(19) United States
(12) Patent Application Publication
(10) Pub. No.: US 2020/0368114 A1
(43) Pub. Date: Nov. 26, 2020

(54) TEAT FOR USE WITH A CONTAINER FOR CONTAINING A FLUID

(71) Applicant: KONINKLIJKE PHILIPS N.V., EINDHOVEN (NL)

(72) Inventors: Johannes Tseard VAN DER KOOI, MUNEIN (NL); Jacob Cornelis Paul DEN DULK, EINDHOVEN (NL); Narasimha SHASTRI, EINDHOVEN (NL); Coen JANSEN, TILBURG (NL)

(21) Appl. No.: 16/769,689

(22) PCT Filed: Nov. 30, 2018
(86) PCT No.: PCT/EP2018/083071

§ 371 Date: Jun. 4, 2020

(30) Foreign Application Priority Data
Dec. 8, 2017 (EP) 17206279.6

(51) Int. Cl. A61J 11/00

(52) U.S. Cl. CPC A61J 11/005

(57) ABSTRACT

A teat (1) for use with a container for containing a fluid comprises a deformable mouthpiece (13) for an infant to suck on, and an inner core (20) disposed within the mouthpiece (13). The mouthpiece (13) has at least one aperture (12) therein for allowing a fluid to flow out of the teat (1). A fluid duct (30) between the mouthpiece (13) and the inner core (20) is defined at the position of a fluid pocket guiding face (23) of the inner core (20) whereby the infant is allowed to perform a peristaltic fluid intake action. The at least one aperture (12) is arranged in a central front area (15) of the mouthpiece (13), while the mouthpiece (13) and the inner core (20) are designed to leave space between them for a fluid flow path from the fluid pocket guiding face (23) to the at least one aperture (12).

### FIELD OF THE INVENTION

The invention relates to a teat for use with a container for containing a fluid, comprising: a deformable mouthpiece for an infant to suck on during a fluid intake action, the mouthpiece having at least one aperture therein for allowing a fluid to flow out of the teat; and an inner core disposed within the mouthpiece, wherein an exterior surface of the inner core is spaced from an interior surface of the mouthpiece at the position of a fluid pocket guiding face of the exterior surface of the inner core extending along a length of the inner core so that a fluid duct between the mouthpiece and the inner core is defined which allows the infant to perform a peristaltic fluid intake action during which the mouthpiece is deformed and a fluid is forced along the fluid duct in a direction towards the at least one aperture of the mouthpiece.

The invention furthermore relates to an assembly comprising a teat as mentioned and a container for containing a fluid. Such an assembly may be a feeding bottle assembly comprising a feeding bottle for containing a feeding fluid such as milk, for example.

### BACKGROUND OF THE INVENTION

A teat as defined in the foregoing is known from WO 2010/004487 A1. The design of the teat is aimed at rewarding an infant for making a natural peristaltic tongue movement that is normally only related to breast feeding. In general, the teat is configured to allow an infant to realize a flow of fluid from the teat under the influence of the natural peristaltic tongue movement as mentioned. As an advantageous consequence, there is no need for the infant to develop another fluid intake action than a natural breast-feeding action, so that problems which might otherwise occur when switching between bottle feeding and breast feeding are prevented.

The teat known from WO 2010/004487 A1 has a mouthpiece on which an infant sucks during a fluid intake action, particularly a feeding action. The mouthpiece extends from a main body and has one or more apertures therein for a flow of fluid out of the teat. A well-known example of a fluid used for feeding purposes is milk. Furthermore, the teat has an inner core that is disposed within the mouthpiece in such a way that a fluid duct is defined between the inner core and the mouthpiece. During fluid intake, at least one of the inner core and the mouthpiece deforms so as to allow for a peristaltic action which causes fluid to flow along the fluid duct and eventually out of the teat through the at least one aperture of the mouthpiece. The teat is configured so that the peristaltic action provides the infant with the most amount of fluid, compared to if the infant was to use a sucking or a chewing action. In this way, the infant is rewarded for using the same fluid intake action as with natural breast feeding.

Various embodiments of the known teat are disclosed in WO 2010/004487 A1. In a number of those embodiments, the exterior surface is provided with an arced face or recess that extends along a length of the inner core, so that space is present between the inner core and the mouthpiece at the position of the arced face or recess of the exterior surface of the inner core. In such a configuration, a fluid duct is defined between the mouthpiece and the inner core at the position of the arced face or recess of the exterior surface of the inner core.

EP2296604 also discloses a peristaltic teat. The peristaltic teat is a cleanable teat which rewards the baby for making the same natural peristaltic tongue movement it makes at the mother's breast. The reward is that the baby gets (more) milk when making the correct movement. The consequence is that the baby will use the same drinking mechanism as at the breast. Hence bottle feeding will become closer to breast feeding which makes the combination of bottle feeding and breast feeding easier.

### SUMMARY OF THE INVENTION

Although the known teat functions well and achieves the advantageous effects as described in the foregoing, there is room for improvement of the design of the teat. It is an object of the invention to provide a teat of the type known from WO 2010/004487 A1 and to design the teat in such a way that blockage of the at least one aperture of the mouthpiece, either by the tongue or the palate of an infant, or by the inner core, during a fluid intake action, is prevented. In view thereof, the invention provides a teat as defined in the opening paragraph, wherein the at least one aperture of the mouthpiece is arranged in a central front area of the mouthpiece, and wherein the mouthpiece and the inner core are designed to leave space between them for a fluid flow path from the fluid pocket guiding face to the at least one aperture.

It is noted that in the present description, terms such as front, back, forward and backward are to be understood so as to be related to a normal flow of milk through the teat, as intended to be supplied to an infant. Hence, a front area of the mouthpiece is an area that is intended to extend the furthest into the mouth of an infant during a fluid intake action. Further, terms implying an upper and lower level on the teat are to be understood so as to be related to a normal operational orientation of the teat, which is an orientation in which the fluid pocket guiding face is at a position for facing downward, i.e. at a position for facing an infant's tongue.

Providing a teat with an inner core has a limiting effect on the possibilities in respect of positioning the at least one aperture in the mouthpiece. In this respect, reference is made to WO 2010/004487 A1 once again, as this document illustrates embodiments of the teat in which the mouthpiece has a single aperture and in which the aperture is arranged at a position in the mouthpiece which is not at the front of the mouthpiece and which is not central in the mouthpiece either. The design of such embodiments is aimed at having the inner core and the fluid pocket guiding face defined thereon on the one hand, so that the desired peristaltic action can be realized during use of the teat, and at having the at least one aperture at a position for receiving and letting out a quantity of fluid as advanced along the fluid pocket guiding face during use.

One of the insights underlying the invention is that in general, when the option of having an inner core is not taken into account, it is most practical to position the at least one aperture in a central front area of the mouthpiece. It appears that when the at least one aperture is position in another area of the mouthpiece, there is a risk of the at least one aperture getting blocked by the tongue or the palate of an infant during a fluid intake action. Especially the relatively flexible tongue appears to be capable of covering the at least one aperture in such a situation, in which case the tongue acts as a barrier between the interior of the teat and the exterior of the teat, so that a flow of fluid from the teat is hindered if not completely stopped.

The invention provides a way of combining optimal positioning of the at least one aperture with optimal functionality of the teat when it comes to enabling a peristaltic fluid intake action. In particular, according to the invention, the at least one aperture of the mouthpiece is arranged in a central front area of the mouthpiece, and the mouthpiece and the inner core are designed to leave space between them for a fluid flow path from the fluid pocket guiding face to the at least one aperture. The invention relies on another principle than choosing the positioning of the at least one aperture so as to be outside of a central front area of the mouthpiece in case an interior side of the central front area is covered by an inner core, and provides an adapted design of the mouthpiece and/or the inner core in order to have the best possible fluid supplying functionality of the teat and optimum reliability of the teat. It is to be noted that the design of one or both of the mouthpiece and the inner core can be adapted. It may be practical for the mouthpiece to still be of conventional design and to only have the inner core adapted, but that does not alter the fact that other options are covered by the invention as well.

The interior surface of the mouthpiece and a middle area of the fluid pocket guiding face which is central as seen in a peripheral direction of the teat are further offset from each other along a front part of the fluid pocket guiding face than towards an adjacent part of the fluid pocket guiding face that is more to the back. For example, it may be so that an offset distance between the interior surface of the mouthpiece and the middle area of the fluid pocket guiding face has a predetermined value along a length of the fluid pocket guiding face with the exception of a front part of the fluid pocket guiding face where the value of the offset distance is larger. In any case, according to this option, a continuous and unobstructed fluid flow path along the fluid pocket guiding face towards at least one aperture which is arranged in a central front area of the mouthpiece is realized by having a relatively large offset distance between the interior surface of the mouthpiece and a middle area of the fluid pocket guiding face at the position of a front part of the fluid pocket guiding face. For example, the inner core may be designed such that the part of the fluid pocket guiding face actually leading up to the at least one aperture is set back to a position for leaving space for the fluid to eventually reach the at least one aperture. For the sake of clarity, the at least one aperture which is arranged in a central front area of the mouthpiece will hereinafter be referred to as the at least one centrally arranged aperture.

It follows from the foregoing that it may be so that an inclination of the inner core at the position of the fluid pocket guiding face near the front side of the fluid pocket guiding face is large compared to an inclination more to the back of the fluid pocket guiding face. In other words, the invention includes an embodiment of the teat in which a front part of the fluid pocket guiding face is deflected upwardly with respect to an inclination of a connected area of the fluid pocket guiding face which is more to the back, as seen in a longitudinal direction towards the at least one aperture. As a result, the design of the inner core is suitable for allowing free fluid communication between a centrally arranged aperture and the fluid duct between the mouthpiece and the inner core.

In general, the front part of the fluid pocket guiding face may be designed to have a suitable kind of recessed appearance so as to not block a fluid flow path towards at least one centrally arranged aperture. According to one exemplary option, at least a front part of the fluid pocket guiding face comprises two surfaces defining a gutter-like recess having a V-shaped cross-sectional appearance, in which case the fluid can reach the aperture along the middle line of the recess. According to another exemplary option, a front part of the fluid pocket guiding face is provided with an elongated central recess extending longitudinally in the direction of the at least one aperture. An option like the first one is the most preferred, as during use, fluid that is present in the recess can be directly pressurized under influence of an infant's tongue action. The invention also covers an additional or alternative option according to which the inner surface of the mouthpiece comprises two surfaces defining a gutter-like recess having a V-shaped cross-sectional appearance, as well as an additional or alternative option according to which the inner surface of the mouthpiece is provided with an elongated recess extending longitudinally in the direction of the at least one aperture.

In another embodiment, a front portion of the inner core may be provided with a channel extending through the inner core between a position on the fluid pocket guiding face and a central front area of the inner core. Provided that this channel has only limited length, it is possible for fluid that is moved along the fluid pocket guiding face to flow through the channel as well and exit the inner core at a position for immediately reaching a centrally arranged aperture of the mouthpiece, i.e. at a position on the inner core corresponding to the position of the centrally arranged aperture.

In yet another embodiment, the inner core may be cropped, as it were, with respect to a conventional design, so as to leave space for fluid, which space would otherwise be occupied by a front portion of the inner core. In such an embodiment, it may be practical for a front face (front plateau) of the inner core to be delimited along at least a top edge thereof by a protrusion for sealing the inner core against the mouthpiece, as back flow of fluid can be prevented in that way.

In a practical embodiment of the teat, the mouthpiece only has a single aperture therein. In such a case, it may be so that the aperture is arranged substantially in the middle of the central front area of the mouthpiece. Alternatively, the aperture may be arranged at a limited distance from the middle of the central front area of the mouthpiece, preferably at a position above the middle so as to be more at the palate side of the teat than at the tongue side of the teat, as in general, the risk of the aperture getting blocked is highest at the tongue side of the teat.

For the sake of completeness, it is noted that it is practical for the fluid pocket guiding face to be at least one of an arced face and a recessed face of the exterior surface of the inner core. In respect of the possibility of the fluid pocket guiding face having an arced shape, it is noted that the fluid pocket guiding face may have a generally concave shape in that case. In respect of the additional or alternative possibility of the fluid pocket guiding face being provided in the form of a recessed face of the exterior surface of the inner core, it is noted that the fluid pocket guiding face may be recessed with respect to what would be an outline of the exterior surface for more or less closely following a peripheral shape of the mouthpiece in that case.

It may be advantageous for the inner core to comprise at least one protrusion extending at an edge position of the fluid pocket guiding face for delimiting the fluid pocket guiding face, as this may be an important factor in preventing or at least largely hindering leakage of fluid from between the mouthpiece and the inner core at the position of the sides of the fluid pocket guiding face, so that the extent to which back flow of the fluid as a result of such leakage can take place may be minimized.

In conformity with what is known from WO 2010/004487 A1, it is noted that the inner core may be removable from the mouthpiece. This may be beneficial in view of cleanability of the teat, which does not alter the fact that the invention also covers a teat in which the inner core is integrally formed with the mouthpiece. When it comes to realizing good cleanability of the teat, it may be so that the mouthpiece and any body from which it may extend are invertible, i.e. can be turned inside out. Furthermore, it is practical for the teat to comprise a support frame that is configured and arranged to support the inner core in the teat. The inner core may be realized in any suitable way and may comprise any suitable material or combination of materials.

The invention also relates to an assembly which comprises a teat as described in the foregoing, i.e. a teat which is equipped with an inner core an a mouthpiece encompassing the inner core, the at least one aperture of the mouthpiece being arranged in a central front area of the mouthpiece, and the mouthpiece and the inner core being designed to leave space between them for a fluid flow path from the fluid pocket guiding face to the at least one aperture, and which further comprises a container for containing a fluid.

The above-described and other aspects of the invention will be apparent from and elucidated with reference to the following detailed description of two embodiments of a teat comprising an inner core and a mouthpiece encompassing the inner core, which teat is designed to prevent an aperture as present in the mouthpiece for letting out fluid from the teat from getting blocked.

### BRIEF DESCRIPTION OF THE DRAWINGS

The invention will now be explained in greater detail with reference to the figures, in which equal or similar parts are indicated by the same reference signs, and in which:

FIG. 1 diagrammatically shows a perspective view of an outer membrane of a teat according to a first embodiment of the invention, which teat is particularly designed to stimulate an infant to use a natural peristaltic fluid intake action for drawing fluid from the teat;

FIG. 2 diagrammatically shows a front view of the outer membrane;

FIG. 3 diagrammatically shows a perspective view of a combination of an inner core and a support frame of the inner core, which combination is part of the teat besides the outer membrane;

FIG. 4 diagrammatically shows a side view of a longitudinal section of the teat;

FIGS. 5 and 6 illustrate how a fluid pocket is formed during use of the teat;

FIGS. 7 and 8 illustrate how the design of the inner core is adapted in order to enable unobstructed fluid flow through the teat and towards an aperture for letting out fluid from the teat;

FIGS. 9 and 10 diagrammatically show a front view of transverse slices of the teat taken from different longitudinal positions of the teat;

FIG. 11 shows a perspective bottom view of a front part of the inner core of a teat according to a second embodiment of the invention; and

FIGS. 12 and 13 illustrate how the design of the inner core is adapted in order to enable unobstructed fluid flow through the teat and towards an aperture for letting out fluid from the teat.

### DETAILED DESCRIPTION OF EMBODIMENTS

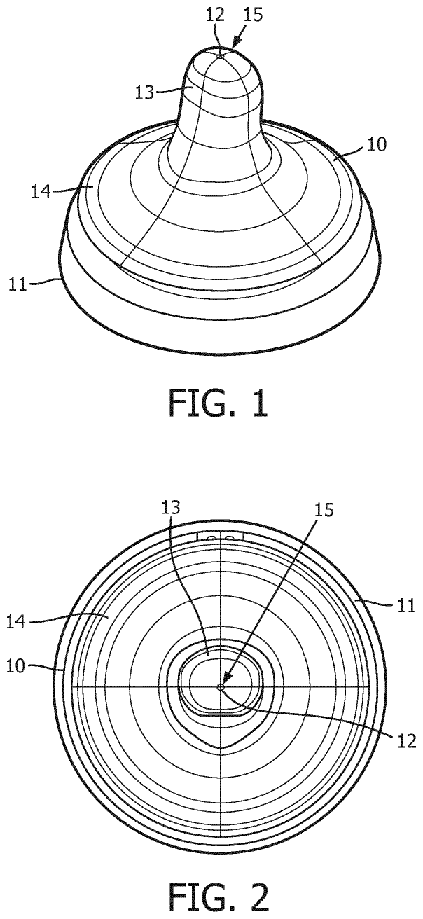

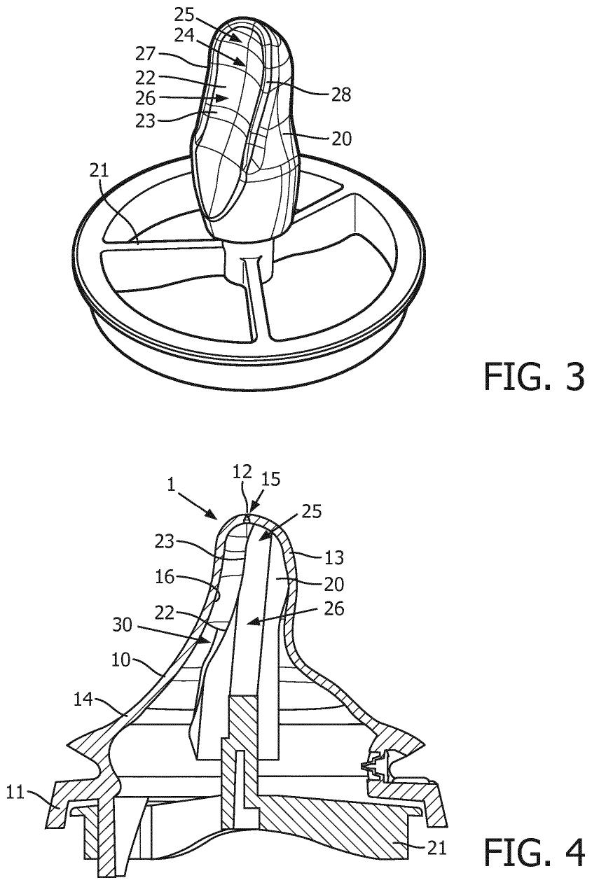

FIGS. 1-4 illustrate a teat 1 according to a first embodiment of the invention, wherein FIGS. 1 and 2 diagrammatically show different views of an outer membrane 10 of the teat 1, wherein FIG. 3 diagrammatically shows a perspective view of a combination of an inner core 20 and a support frame 21 of the inner core 20, which combination is also part of the teat 1, and wherein FIG. 4 diagrammatically shows a sectional view of the teat 1 in assembled condition.

The teat 1 is designed to stimulate an infant to use a natural peristaltic fluid intake action for drawing fluid from the teat 1. In view thereof, the teat 1 will be referred to as peristaltic teat. Further, at various positions in the following description, the fluid is referred to as being milk, which should not be understood so as to mean that the use of the peristaltic teat 1 is restricted to this particular type of fluid. In this respect, it is noted that other examples of fluid that may be supplied to an infant by means of the peristaltic teat are water, porridge-like fluid, and medicinal fluid.

Like any conventional teat, the peristaltic teat 1 is intended to be connected to a container (not shown) which is suitable for containing an amount of fluid to be supplied to an infant, and which may be of any design and type. For example, the peristaltic teat 1 may be used in combination with a feeding bottle that is provided with external screw thread at an open side thereof and a connecting ring that is provided with internal screw thread, in which case a flange-like portion 11 of the teat 1 can be retained between the connecting ring and the bottle in an interconnected condition of the connecting ring and the bottle that is realized by engagement of the respective screw threads. The peristaltic teat 1 has at least one aperture 12 for letting out milk from the teat 1. In the shown example, the peristaltic teat 1 has only one aperture 12. As mentioned earlier, terms such as front, back, forward and backward are to be understood so as to be related to a normal flow of milk through the peristaltic teat 1, as intended to be supplied to an infant, i.e. a flow of milk in a direction from the flange-like portion 11 to the aperture 12.

The outer membrane 10 of the peristaltic teat 1 is hollow and flexible, and basically has two portions, namely a mouthpiece 13 and a main body 14. The mouthpiece 13 extends from the main body 14, wherein the mouthpiece 13 comprises the aperture 12 as mentioned earlier at a front side thereof, and wherein the main body 14 comprises the flange-like portion 11 as mentioned earlier at a back side thereof. In the shown example, the inner core 20 is shaped like a kind of plug which is disposed within the mouthpiece 13 in the assembled condition of the peristaltic teat 1. In this configuration, a fluid duct 30 is defined between the mouthpiece 13 and the inner core 20 for accommodating a flow of milk that is directed towards the aperture 12 for the purpose of supplying the milk to an infant during use of the peristaltic teat 1. A portion of the inner core 20 may project from the mouthpiece 13 in a backward direction, extending into the main body 14.

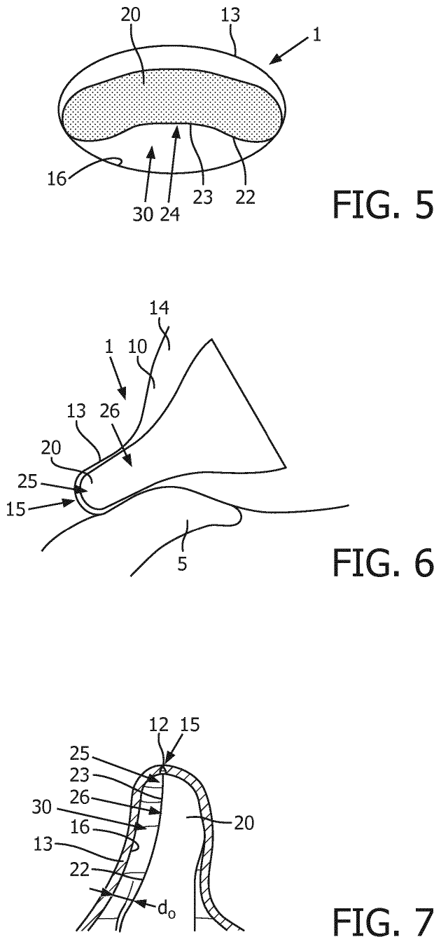

With reference to FIGS. 5 and 6, operation of the peristaltic teat 1 according to the invention will now be described. In use, the peristaltic teat 1 is connected to a feeding bottle or the like, as explained earlier. The infant sucks on the mouthpiece 13 which is sufficient to realize an initial, small flow of milk from the feeding bottle into the fluid duct 30. However, in order to obtain a full flow of milk from the feeding bottle out of the peristaltic teat 1, the infant must perform a peristaltic fluid intake action by which a wave of compression is exerted by the infant's tongue 5 on the mouthpiece 13, in a direction towards the front side of the mouthpiece 13. In the process, the mouthpiece 13 deforms, and the fluid duct 30 is locally compressed by the infant's tongue 5, at successive levels of the fluid duct 30 in the direction as mentioned, so that a milk-filled pocket is pressed forward through the fluid duct 30. When the milk-filled pocket is at the front side of the mouthpiece 13, the milk is expelled out of the aperture 12 into the infant's mouth. The infant then repeats the peristaltic fluid intake action, commencing at the back side, i.e. the main body side of the mouthpiece 13. By repeating the peristaltic fluid intake action over and over again, continuous fluid intake is realized.

According to the invention, as explained earlier, the peristaltic teat 1 is configured so that the peristaltic fluid intake action provides the infant with the most amount of milk, compared to if the infant was to use a sucking or a chewing action. Accordingly, the infant is rewarded for using the same fluid intake action as with natural breast feeding, and so the problem of nipple confusion in switching between bottle feeding and breast feeding is prevented since the infant learns to use the same fluid intake action for both fluid intake methods.

In order to facilitate cleaning of the peristaltic teat 1, the inner core 20 may be removable from the membrane 10. This may particularly be achievable by turning the membrane 10 inside out and cleaning the membrane 10 separately from the inner core 20.

In a general sense, it will be appreciated that a peristaltic fluid intake action essentially involves locally closing a duct in which fluid is contained, thereby forming a fluid-filled pocket, and moving the fluid-filled pocket in the direction of the aperture 12 for expelling the fluid from the peristaltic teat 1, by moving the position of the local closure. An exterior surface 22 of the inner core 20 is provided with an arced face that extends along a length of the inner core 20 and that is referred to as fluid pocket guiding face 23 in view of the fact that it serves for delimiting the fluid duct 30 at the side of the inner core 20 and thereby serves for guiding fluid pockets on the exterior surface 22 of the inner core 20 during a fluid intake action. The fluid pocket guiding face 23 is intended to be at a bottom side of the peristaltic teat 1 when the teat 1 is used in a fluid intake action, so that an infant can make a peristaltic tongue movement on the mouthpiece 13, thereby locally pressing the mouthpiece 13 in the direction of the fluid pocket guiding face 23 at successive levels of the inner core 20. The fluid pocket guiding face 23 preferably has a generally concave shape, as is the case in the shown example, and is recessed with respect to what would be an outline of the exterior surface 22 for more or less following the circular or elliptical peripheral shape of the mouthpiece 13.

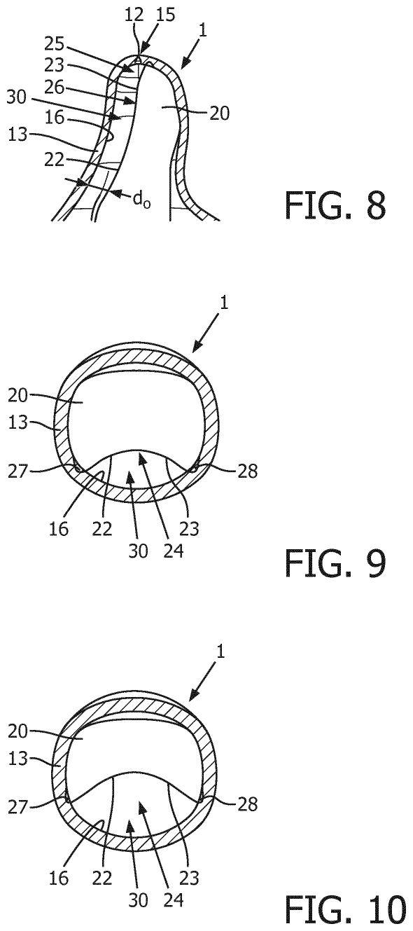

In FIGS. 1 and 2, it can be seen that the aperture 12 is located in a central front area 15 of the mouthpiece 13. FIGS. 7 and 8, and also FIGS. 9 and 10 illustrate how in the first embodiment of the peristaltic teat 1, the design of the inner core 20 is adapted in order to enable unobstructed fluid flow through the teat 1 and towards the aperture 12, as will now be explained.

FIG. 8 diagrammatically shows a side view of a longitudinal section of the peristaltic teat 1, so that the outline of a middle area 24, i.e. an area 24 of the fluid pocket guiding face 23 extending in the longitudinal direction while having a central position on the fluid pocket guiding face 23, relative to the outline of an interior surface 16 of the mouthpiece 13 can be seen. FIG. 8 provides an illustration of the fact that an offset distance do between the interior surface 16 of the mouthpiece 13 and the middle area 24 of the fluid pocket guiding face 23 is substantially the same at every level, i.e. is substantially constant along the length of the fluid pocket guiding face 23. An exception to this general configuration is found at a front part 25 of the fluid pocket guiding face 23 where the offset distance do as mentioned is larger. FIG. 7 provides an illustration of a situation in which the offset distance do would be substantially the same along the entire length of the fluid pocket guiding face 23. It follows from a comparison between FIGS. 7 and 8 that in the peristaltic teat 1 according to the invention, the front part 25 of the fluid pocket guiding face 23 is deflected upwardly to an increased extent when compared to the outline of a connected area 26 of the fluid pocket guiding face 23 which is more to the back, as seen in the longitudinal direction towards the aperture 12. In this respect, it is noted for the sake of completeness that an upward direction is a direction generally to the right in FIGS. 7 and 8, assuming that the fluid pocket guiding face 23 is at a bottom position in an operational orientation of the peristaltic teat 1, as indicated earlier.

If the front part 25 of the fluid pocket guiding face 23 would not have a deviating design for realizing a larger offset distance do, the inner core 20 would be in a position for blocking a fluid flow to the aperture 12, as can be derived from FIG. 7. By having an adapted outline of the fluid pocket guiding face 23 at the position of the front part 25 thereof, a configuration is realized in which space is left for the fluid flow path towards the aperture 12. In this way, it is possible to have the aperture 12 arranged in the central front area 15 of the mouthpiece 13 while still avoiding a situation in which the fluid flow path towards the aperture 12 gets blocked during use of the peristaltic teat 1. The invention also covers an additional or alternative option of the mouthpiece 13 being of adapted design, wherein especially the outline of the interior surface 16 of the mouthpiece 13 is chosen such that the effect of unobstructed fluid flow is obtained.

A non-limiting, practical example of dimensions is as follows. A length of the fluid pocket guiding face 23 may be in a range of about 20 to 25 mm, and a diameter of the mouthpiece 30 may be in a range of about 12 to 15 mm. In such a context, the relatively large offset distance do at the front may be in a range of about 5 to 7 mm, whereas the smaller offset distance do more to the back may be in a range of about 3 to 4 mm, assuming that average tongue displacement is in the same range, i.e. the range of about 3 to 4 mm. The relatively large offset distance do may be present along a length of 5 mm, for example.

The above-described aspects of the design of the inner core 20 can be further understood when a comparison is made of FIGS. 9 and 10. FIGS. 9 and 10 diagrammatically show a front view of transverse slices of the peristaltic teat 1 taken from different longitudinal positions of the teat 1, wherein FIG. 9 diagrammatically shows a front view of a transverse slice taken at a level that is more to the back, and wherein FIG. 10 diagrammatically shows a front view of a transverse slice taken at a level that is more to the front. It follows from a comparison between the figures that at the level that is more to the front, the space that is left clear by the inner core 20 is larger than at the level that is more to the back, and the inner core 20 is out of the way of a central area. FIGS. 9 and 10 provide insight in the fact that in the shown example, the inner core 20 comprises a gutter-like recess having a generally curved cross-sectional appearance at the position of the fluid pocket guiding face 23. Alternative shapes of the fluid pocket guiding face 23 are very well possible within the framework of the invention, such as shape that involves a V-shaped cross-sectional appearance rather than a curved cross-sectional appearance. Also, it is possible for the mouthpiece 13 instead of the inner core 20 to be provided with a gutter-like recess, or for both the mouthpiece 13 and the inner core 20 to be provided with a gutter-like recess, in which case the designs of the mouthpiece 13 and the inner core 20 may be such that the recess of the mouthpiece 13 and the recess of the inner core 20 are positioned so as to be aligned with each other.

FIGS. 9 and 10 further illustrate the option of the inner core 20 being equipped with protrusions 27, 28 extending at an edge position of the fluid pocket guiding face 23 for delimiting the fluid pocket guiding face 23. In particular, the protrusions 27, 28 extend at the sides of the fluid pocket guiding face 23 for contacting the interior surface 16 of the mouthpiece 13 and thereby closing the fluid duct 30 at the sides thereof. During a fluid intake action, on the basis of the presence of the protrusions 27, 28 at the appropriate position alongside the fluid pocket guiding face 23, when a fluid-filled pocket is advanced through the fluid duct 30, the fluid-filled pocket is sealed to the sides thereof at the positions of the longitudinal edges of the fluid pocket guiding face 23, which implies a sealing of the fluid-filled pocket in a peripheral direction of the peristaltic teat 1, i.e. a direction around a longitudinal axis of the teat 1 along the exterior surface 22 of the inner core 20. In that way, leakage of fluid from the fluid duct 30 in a sideward direction is prevented, so that a back flow of fluid is prevented.

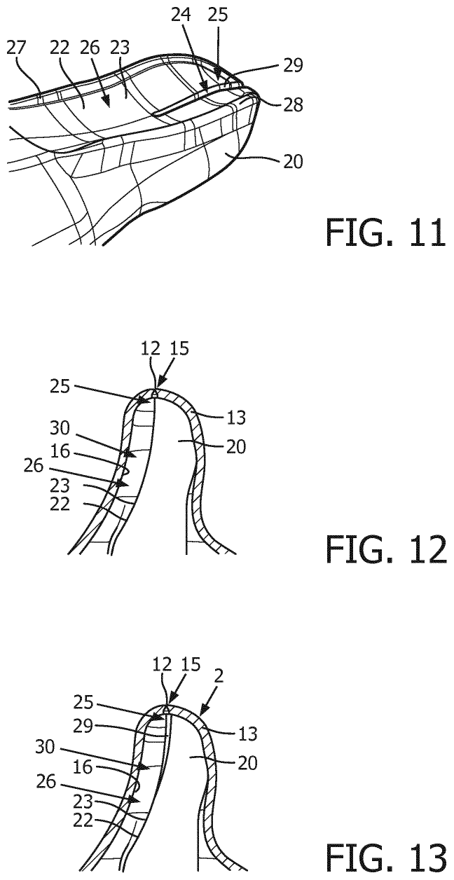

FIGS. 11-13 relate to a peristaltic teat 2 according to the invention, particularly to the option of having an elongated central recess 29 in the front part 25 of the fluid pocket guiding face 23. FIG. 13 diagrammatically shows a side view of a longitudinal section of the peristaltic teat 2, so that the outline of a middle area 24 of the fluid pocket guiding face 23 relative to the outline of an interior surface 16 of the mouthpiece 13 can be seen. FIG. 13 provides an illustration of the fact that at the position of the elongated central recess 29, the fluid flow path towards the aperture 12 is left clear, which would not be the case if the elongated central recess 29 would be omitted, in which case the situation as illustrated in FIG. 12 would be obtained. In fact, in the second embodiment of the peristaltic teat 2, the design of the inner core 20 is adapted to a minimal extent only, for realizing an appearance which is further recessed relative to the fluid pocket guiding face 23 at the very position where the fluid flow path meets the aperture 12. In any case, in the second embodiment of the peristaltic teat 2, as in the first embodiment of the peristaltic teat 1, it is possible to combine the measures for enabling peristaltic fluid intake with a centrally arranged aperture 12. The mouthpiece 13 may also be provided with an elongated recess for this reason.

It is noted that also if more than one apertures 12 are provided, it is possible for all of those apertures 12 to be arranged in a central front area 15 of the mouthpiece 13, and to still avoid cutting off one or more of those apertures 12 to the fluid pockets advanced along the fluid pocket guiding face 23 during use of the teat 1, 2, namely by having an appropriate design of the inner core 20, other than a default design for following the outline of the interior surface 16 of the mouthpiece 13 in a certain way. Further, for the sake of clarity, in respect of the central front area 15 of the mouthpiece 13, it is noted that this is a front area of the mouthpiece 13 that has a central position on the mouthpiece 13, i.e. a front area of the mouthpiece 13 that is intersected by a central longitudinal axis of the mouthpiece 13. The central front area 15 of the mouthpiece 13 has limited dimensions so that any person skilled in the art will denote the area 15 so as to be a central area. This means that the invention covers teats comprising only one aperture 12, in which case the aperture 12 may be arranged so as to be intersected by the central longitudinal axis of the mouthpiece 13 or so as to be close to the central longitudinal axis of the mouthpiece 13, within a practical range of 1 mm, at the most 2 mm, from the central longitudinal axis of the mouthpiece 13. This also means that the invention covers teats comprising two or more apertures 12, in which case one of those apertures 12 may be arranged so as to be intersected by the central longitudinal axis of the mouthpiece 13, wherein the other apertures 12 or all of the apertures 12 may be arranged so as to be close to the central longitudinal axis of the mouthpiece 13, within a practical range of 1 mm, at the most 2 mm, from the central longitudinal axis of the mouthpiece 13.

It will be clear to a person skilled in the art that the scope of the invention is not limited to the examples discussed in the foregoing, but that several amendments and modifications thereof are possible without deviating from the scope of the invention as defined in the attached claims. It is intended that the invention be construed as including all such amendments and modifications insofar they come within the scope of the claims or the equivalents thereof. While the invention has been illustrated and described in detail in the figures and the description, such illustration and description are to be considered illustrative or exemplary only, and not restrictive. The invention is not limited to the disclosed embodiments. The drawings are schematic, wherein details that are not required for understanding the invention may have been omitted, and not necessarily to scale.

Variations to the disclosed embodiments can be understood and effected by a person skilled in the art in practicing the claimed invention, from a study of the figures, the description and the attached claims. In the claims, the word “comprising” does not exclude other steps or elements, and the indefinite article “a” or “an” does not exclude a plurality. Any reference signs in the claims should not be construed as limiting the scope of the invention.

Elements and aspects discussed for or in relation with a particular embodiment may be suitably combined with elements and aspects of other embodiments, unless explicitly stated otherwise. Thus, the mere fact that certain measures are recited in mutually different dependent claims does not indicate that a combination of these measures cannot be used to advantage.

The term “comprise” as used in this text will be understood by a person skilled in the art as covering the term “consist of”. Hence, the term “comprise” may in respect of an embodiment mean “consist of”, but may in another embodiment mean “contain/include at least the defined species and optionally one or more other species”.

In case the teat 1, 2 according to the invention is of the type that can be disassembled, which is the case when the inner core 20 is removable from the mouthpiece 13, for example, the teat 1, 2 is within the scope of the invention in any possible condition thereof, particularly an assembled condition or a disassembled condition.

The invention can be summarized as follows. A teat 1, 2 for use with a container for containing a fluid comprises a deformable mouthpiece 13 for an infant to suck on during a fluid intake action, and an inner core 20 disposed within the mouthpiece 13. The mouthpiece 13 has at least one aperture 12 therein for allowing a fluid to flow out of the teat 1, 2. A fluid duct 30 between the mouthpiece 13 and the inner core 20 is defined at the position of a fluid pocket guiding face 23 of the inner core 20 whereby the infant is allowed to perform a peristaltic fluid intake action. The at least one aperture 12 is arranged in a central front area 15 of the mouthpiece 13, while the mouthpiece 13 and the inner core 20 are designed to leave space between them for a fluid flow path from the fluid pocket guiding face 23 to the at least one aperture 12.

1. A teat for use with a container for containing a fluid, comprising:
a deformable mouthpiece for an infant to suck on during a fluid intake action, the mouthpiece having at least one aperture therein for allowing a fluid to flow out of the teat; and
an inner core disposed within the mouthpiece, wherein an exterior surface of the inner core is spaced from an interior surface of the mouthpiece at the position of a fluid pocket guiding face of the exterior surface of the inner core extending along a length of the inner core so that a fluid duct between the mouthpiece and the inner core is defined which allows the infant to perform a peristaltic fluid intake action during which the mouthpiece is deformed and a fluid is forced along the fluid duct in a direction towards the at least one aperture of the mouthpiece, wherein the at least one aperture is arranged in a central front area of the mouthpiece, and wherein the mouthpiece and the inner core are designed to leave space between them for a fluid flow path from the fluid pocket guiding face to the at least one aperture,
characterized in that the interior surface of the mouthpiece and a middle area of the fluid pocket guiding face which is central as seen in a peripheral direction of the teat are further offset from each other along a front part of the fluid pocket guiding face than towards an adjacent part of the fluid pocket guiding face that is more to the back.

2. The teat according to claim 1, wherein an offset distance between the interior surface of the mouthpiece and the middle area of the fluid pocket guiding face has a predetermined value along a length of the fluid pocket guiding face with the exception of a front part of the fluid pocket guiding face where the value of the offset distance is larger.

3. The teat according to claim 1, wherein a front part of the fluid pocket guiding face is deflected upwardly with respect to an inclination of a connected area of the fluid pocket guiding face which is more to the back, as seen in a longitudinal direction towards the at least one aperture.

4. The teat according to claim 1, wherein at least a front part of the fluid pocket guiding face comprises two surfaces defining a gutter-like recess having a V-shaped cross-sectional appearance.

5. The teat according to claim 1, wherein a front part of the fluid pocket guiding face is provided with an elongated central recess extending longitudinally in the direction of the at least one aperture.

6. The teat at according to claim 1, wherein a front portion of the inner core is provided with a channel extending through the inner core between a position on the fluid pocket guiding face and a central front area of the inner core.

7. The teat according to claim 1, wherein the mouthpiece only has a single aperture therein.

8. The teat according to claim 1, wherein the fluid pocket guiding face is at least one of an arced face and a recessed face of the exterior surface of the inner core.

9. The teat according to claim 1, wherein the inner core comprises at least one protrusion extending at an edge position of the fluid pocket guiding face for delimiting the fluid pocket guiding face.

10. The teat according to claim 1, wherein the inner core is removable from the mouthpiece.

11. The teat according to claim 1, comprising a support frame which is configured and arranged to support the inner core in the teat.

12. An assembly comprising a teat according to claim 1 and a container for containing a fluid.
